(19) United States
(12) Patent Application Publication
(10) Pub. No.: US 2006/0259379 A1
(43) Pub. Date: Nov. 16, 2006

(54) Investment vehicle, system and method

(75) Inventors: Joseph S. Schuchert, Big Horn, WY (US); Thomas J.C. Eadington, Corona del Mar, CA (US)

Correspondence Address: FOLEY & LARDNER LLP, P.O. BOX 80278, SAN DIEGO, CA, 92138-0278, US

(73) Assignee: First Q Capital, LLC

(21) Appl. No.: 11/129,688

(22) Filed: May 13, 2005

(51) Int. Cl. G06Q 40/00

(52) U.S. Cl. 705/35

(57) ABSTRACT

Investment vehicles, systems and methods provide for the investment of funds in an investment opportunity selected based on criteria to reduce risk and increase or maximize return. In one embodiment, the risk is reduced by selecting an investment opportunity for investment after the initial public offering (IPO) of the investment opportunity only if the investment opportunity included pre-IPO private-equity funding. Further, if the pre-IPO private-equity funding included venture funding, selection of the investment opportunity for investing requires that certain revenue or profitability criteria be satisfied.

### BACKGROUND OF THE INVENTION

The present invention relates generally to the field of investing. In particular, the present invention relates to investment vehicles, systems and methods adapted to reduce risk and increase return.

Most investment opportunities are accompanied by an inherent risk. The risk may be associated with overall market fluctuations and economic, social or political factors. A direct factor contributing to the risk relates to the uncertainty of the future performance of an entity, such as a corporation, associated with the investment. Concurrently, investors are concerned with finding investment opportunities in growing industries and companies that exploit new markets and innovate existing markets to increase profits. Several strategies have been proposed to reduce such risks. For example, diversification of a portfolio of investments can reduce the risk to an entire portfolio. However, individual investments within the portfolio may remain exposed to risk.

It is desirable to provide an investment vehicle, system and method for reducing or minimizing the risk, as well as increasing or maximizing the return, associated with an investment.

### SUMMARY OF THE INVENTION

The disclosed embodiments of the invention provide for the investment of funds in an investment opportunity selected based on criteria to reduce risk and increase return. In one embodiment, the risk is reduced and return maximized by selecting an investment opportunity for investment after the initial public offering (IPO) of the investment opportunity only if the investment opportunity included pre-IPO private-equity funding. Further, if the pre-IPO private-equity included venture funding, selection of the investment opportunity for investing requires that certain revenue or profitability criteria be satisfied.

In one aspect, the invention relates to an investment method including selecting a post-IPO investment opportunity for investing only if pre-IPO funding of the post-IPO investment opportunity includes private equity funding.

As used herein, an “investment opportunity” refers to an opportunity to invest funds, such as for purchasing an equity position, in an entity such as a company, for example.

As used herein, “post-IPO” refers to the period after an initial public offering of a company. The company may be publicly traded, and the investment opportunity may include the opportunity to purchase publicly traded securities.

As used herein, “pre-IPO funding” refers to the source or sources of capital which may be required to start an entity and maintain or grow the entity through the IPO. For example, prior to the IPO, a company may require capital to develop a product or market a service. Additional capital may be required until the company is either profitable or completes an IPO to cover operating expenses, for example.

As used herein, “private equity funding” refers to funding from a non-public source, such as through a buyout (unleveraged), a leveraged buyout (LBO), or a venture fund, for example. “Private-equity funding,” as that phrase is used in the financial arts, refers generally to a group, a fund, an entity or other organization that has repeated and/or iterative investments as its primary purpose. In addition to the above-described examples, such-private-equity funding may come from a company having an investment arm, such as a venture group. As a matter of distinction, non-private equity funding arises from unorganized, ad hoc investment by individuals, companies, company executives, family or friends, for example. These ad hoc groups may organize for the purpose of investing in a single investment opportunity, rather than as group investing in a series of different investment opportunities over an extended period of time.

In a particular embodiment, the method also includes determining, if the private-equity funding includes venture funding, whether the post-IPO investment opportunity satisfies revenue or profitability criteria. The revenue or profitability criteria may be predetermined. In one embodiment, the revenue or profitability criteria is based on at least one of the following factors: size of investment, size of an entity affiliated with the investment opportunity and number of employees.

As used herein, “determining” may include evaluating, calculating or discovering, for example.

“Venture funding” may include funding from a fund formed specifically for investment in a specific type of venture, such as pre-IPO ventures, telecommunication ventures or biotech ventures, for example.

“Revenue or profitability criteria” refers to criteria associated with either revenue, profitability or both of an investment opportunity to determine whether an investment should be made. The criteria may require a minimum threshold amount of revenue, profitability or both. The threshold amount may be a function of various factors or it may be a value or a percentage that is fixed.

A “size of investment” may refer to a monetary amount of the investment or a percentage of ownership of the entity affiliated with the investment opportunity.

An “entity” may be a corporation or other publicly traded entity, for example.

As used herein, “affiliated” may refer to a direct or indirect link between the investment opportunity and the affiliated entity. For example, the investment opportunity may include shares of ownership in the affiliated entity.

A “level of investment” may refer to a monetary amount of the investment or a percentage of ownership of the entity affiliated with the investment opportunity.

In particular embodiments, the method also includes determining a level of investment in the post-IPO investment opportunity. Further, the method may include providing funds for investment in the post-IPO investment opportunity corresponding to the level of investment.

Another aspect of the invention includes an investment vehicle. The investment vehicle includes an investment fund for providing investment capital for a post-IPO investment opportunity. The post-IPO investment opportunity is selected only if pre-IPO funding of the post-IPO investment opportunity includes private-equity funding.

As used herein, an “investment vehicle” may include a fund, a financial instrument or a managed account for investing in one or more investment opportunity.

In yet another aspect, the invention includes an investment system having means for selecting a post-IPO investment opportunity for investing only if pre-IPO funding of the post-IPO investment opportunity includes private-equity funding.

Another aspect of the invention includes a program product having machine readable program code for causing a machine to perform the following method step: selecting a post-IPO investment opportunity for investing only if pre-IPO funding of the post-IPO investment opportunity includes private-equity funding.

In another aspect, the invention includes an investment system having an investment server adapted to select a post-IPO investment opportunity for investing only if pre-IPO funding of the post-IPO investment opportunity includes private-equity funding.

As used herein, a “server” includes any computer or computing device provided with software to receive and fulfill requests from other computers or computing devices in, for example, a server-client relationship.

“Data” may include any information relating to the investment opportunity, including data relating to pre-IPO funding and pre- and post-IPO information relating to revenue and/or profits of an affiliated entity, for example. Data may be stored, transmitted, received or manipulated in digital format.

A “data warehouse” may include a database or other storage device for storing the data.

As used herein, a “module” refers to a software, hardware or firmware component. The module may be divided into two or more sub-modules, or two or more modules may be combined into a single module.

In one embodiment, the investment server is adapted to receive data related to the post-IPO investment opportunity from a data warehouse. The investment server may include a funding evaluator module adapted to determine pre-IPO funding based on data received from the data warehouse.

In a particular embodiment, the investment server includes a revenue/profit evaluator module adapted to determine, if the private-equity funding includes venture funding, whether the post-IPO investment opportunity satisfies revenue or profitability criteria.

### BRIEF DESCRIPTION OF THE DRAWINGS

FIG. 1 schematically illustrates a variety of exemplary investment opportunities, along with their respective pre-IPO funding sources;

FIG. 2 is a flow chart illustrating an exemplary investment method;

FIG. 3 is a flow chart illustrating an embodiment of the evaluation of general investment criteria in the investment method of FIG. 2;

FIG. 4 schematically illustrates the flow of investment funds according to an embodiment of the invention; and

FIG. 5 is a schematic illustration of an investment system according to an embodiment of the invention.

### DETAILED DESCRIPTION OF THE PREFERRED EMBODIMENTS

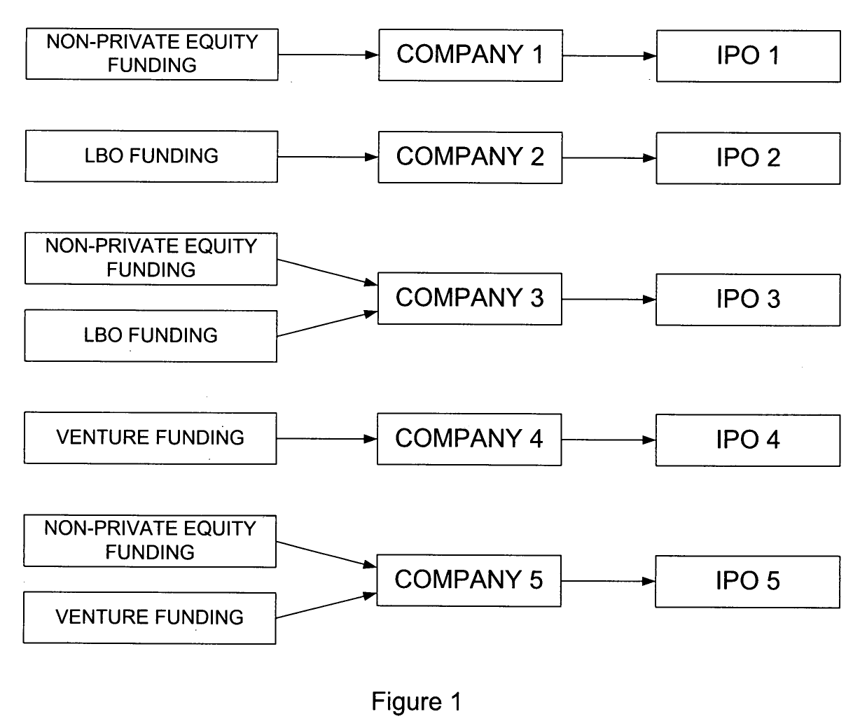

Referring to FIG. 1, a variety of investment opportunities are illustrated schematically. In the illustrated examples, the investment opportunities are entities, such as companies, that have completed an initial public offering (IPO). Thus, the investment opportunity is presented as a post-IPO opportunity.

Before the IPO, each entity may have derived funding from a variety of sources. Such pre-IPO funding may be required to start the entity and maintain or grow the entity through the IPO. For example, prior to the IPO, a company may require capital to develop a product or market a service. Additional capital may be required until the company is either profitable or completes an IPO to cover operating expenses, for example.

FIG. 1 illustrates five investment opportunities, each having an affiliated company having completed an IPO. FIG. 1 also illustrates the source or sources of pre-IPO funding of each company. Company 1 received pre-IPO funding from a non-private source prior to completing IPO 1. As described above, non-private funding may come from ad hoc investment by individuals, companies, company executives, family or friends, for example Companies 2 and 4 received pre-IPO funding from private-equity sources prior to completing IPO 2 and IPO 4, respectively. The private-equity funding source for Company 2 in the illustrated example is a leveraged buyout (LBO), while the private-equity funding for Company 4 is through a venture fund. Companies 3 and 5 received pre-IPO funding from private-equity and non-private sources, with Company 3 receiving its private-equity funding through an LBO and Company 5 receiving the private-equity funding through a venture fund.

According to embodiments of the present invention, the selection of a post-IPO investment opportunity for investing is made to reduce risk. The risk is reduced by investing only in those investment opportunities which include pre-IPO funding from a private-equity source. As has been supported by at least one study, IPO's with private-equity pre-IPO funding generally outperform IPO's with non-private funding. In this regard, private-equity funding may include funding from a non-public source, such as through a buyout, a leveraged buyout (LBO) or a venture fund, for example. By contrast, examples of non-private funding include unorganized, ad hoc investments from companies, government institutions or agencies, friends or families.

Accordingly, in one embodiment, the invention includes an investment vehicle having an investment fund. The investment fund may have been established for providing investment capital for a post-IPO investment opportunity, which is selected only if pre-IPO funding of the post-IPO investment opportunity includes private-equity funding. In this regard, a post-IPO investment opportunity may include the purchase of publicly traded securities in a company anytime during or after an IPO.

Further, in certain embodiments, the investment vehicle may eliminate certain investment opportunities, even if they include private-equity, pre-IPO funding. For example, if the private-equity funding was from a venture fund, additional constraints may be placed. Venture funding may include funding from a fund formed specifically for investment in a specific type of venture, such as pre-IPO ventures, telecommunication ventures or biotech ventures, for example.

In one embodiment, a minimum threshold of revenue, profit or both may be required to select the investment opportunity. In this regard, a predetermined criteria relating to revenue and/or profitability may be provided. The criteria may be based on such factors as the size of the investment being considered, the size of the entity, such as the company, affiliated with the investment opportunity and number of employees. In this regard, the criteria may be, for example, a fixed value or a percentage. The size of the investment may be a monetary amount of the investment or a percentage of ownership of the entity affiliated with the investment opportunity, reflected by the percentage of outstanding shares being purchased, for example.

A level of investment in the post-IPO investment opportunity may be determined according to additional factors, and funds may be provided from the investment vehicle for investment in the post-IPO investment opportunity.

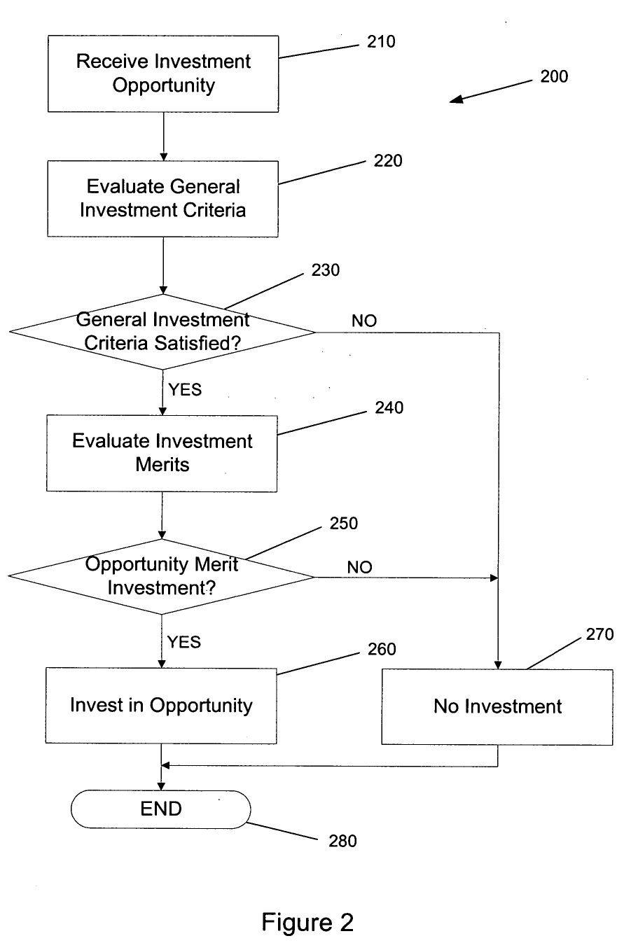

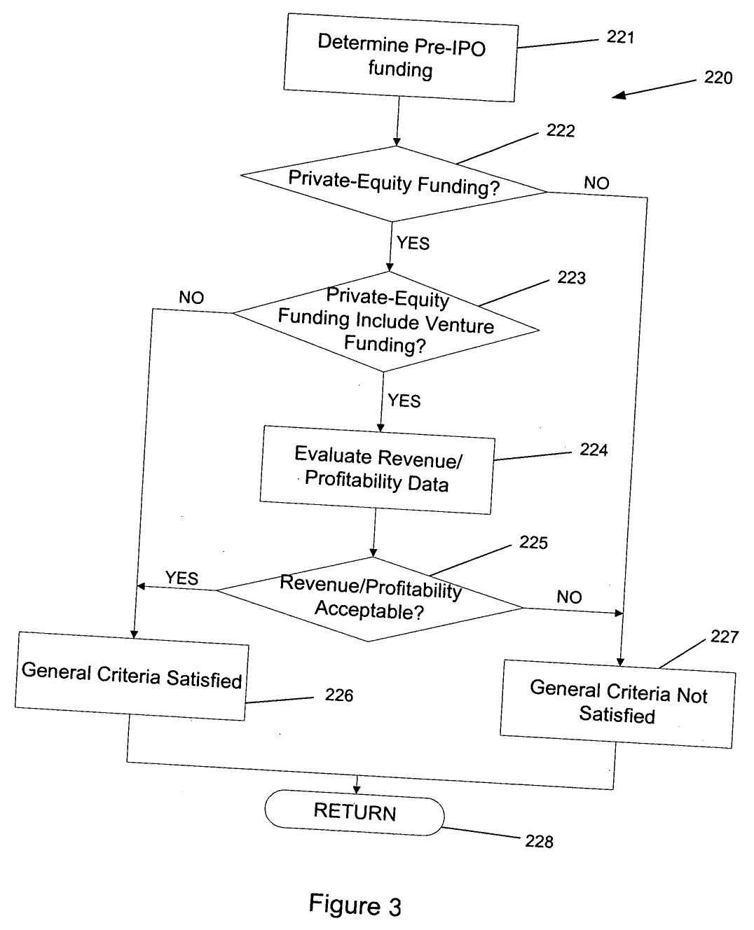

FIGS. 2 and 3 are flow charts illustrating exemplary investment methods according to embodiments of the invention. FIG. 2 illustrates an exemplary overall method for investing. The method 200 begins when an investment opportunity is received (block 210). The investment opportunity may be received from a variety of sources, such as a representative of the entity associated with the investment opportunity or an investor in the investment vehicle or fund, for example. The investment opportunity may be received by a fund manager of the investment vehicle.

At block 220, the investment opportunity is evaluated according to the general investment criteria of the investment vehicle or fund. For example, a fund may be set up to invest only in certain technologies, such as biotech or telecommunications. Further, as illustrated in FIG. 3, additional limitations may be placed on the fund as part of the general investment criteria. At block 230, a determination is made as to whether the investment opportunity satisfies the general investment criteria.

If the determination is made at block 230 that the investment opportunity does not satisfy the general investment criteria, the method proceeds to block 270, and no investment is made in the investment opportunity. On the other hand, if the determination is made at block 230 that the investment opportunity does satisfy the general investment criteria, the method proceeds to block 240, and the investment opportunity is evaluated for its own merits. In this regard, the details of the entity associated with the investment opportunity may be considered to determine the likelihood of a positive return on the investment or to determine an expected return on the investment. Financial and market data may be relevant to this determination. For example, the forecasts for market growth may increase the likelihood of a positive return on an investment. Other factors, such as the direction of the economy in the near and distant future, may also be considered.

At block 250, a determination is made as to whether the investment opportunity merits investment from the investment vehicle or fund. This determination may be made based on a minimum threshold value of the expected return on the investment or the likelihood of a positive return. If the determination is made at block 250 that the investment opportunity does not merit an investment from the investment vehicle or fund, the method proceeds to block 270, and no investment is made. On the other hand, if the determination is made at block 250 that the investment opportunity does indeed merit an investment from the investment vehicle or fund, the method proceeds to block 260, and an investment is made. In this regard, a level of investment may be determined at block 260, and the funds may be provided for investment capital.

Referring now to FIG. 3, an embodiment of the evaluation of general investment criteria (block 220 of FIG. 2) is exemplarily demonstrated by the illustrated flowchart. At block 221, the pre-IPO funding of the investment opportunity is determined. In this regard, information may be obtained regarding the sources of pre-IPO funding of the entity associated with the investment opportunity. The information may be obtained from the entity or from an independent information service, for example.

At block 222, a determination is made as to whether any pre-IPO funding included private-equity funding. As noted above, private-equity funding may include buyout, leveraged buyout (LBO) or venture funding.

If the determination is made at block 222 that the pre-IPO funding did not include any private-equity funding, the method proceeds to block 227 and determines that the general investment criteria is not satisfied. At block 228, the method then returns to block 230 of the method illustrated in FIG. 2, and no investment is made.

On the other hand, if the determination is made at block 222 that the pre-IPO funding included at least some private-equity funding, the method proceeds to block 223, and a further determination is made as to the nature of the private-equity funding. Specifically, at block 223, a determination is made as to whether the private-equity funding included any venture funding. If the determination is made at block 223 that the private-equity funding did not include any venture funding, the method proceeds to block 226 and determines that the general investment criteria is satisfied.

On the other hand, if the determination is made at block 223 that the private-equity funding included venture funding, the method proceeds to block 224, and information relating to revenue, profitability or both of the entity is evaluated. In this regard, such information may be obtained from either the entity or from an independent information source, for example.

At block 225, a determination is made as to whether a the revenue, profitability or both of the entity is acceptable for investment from the investment vehicle or fund. As noted above, predetermined criteria may be applied to make this determination. If the revenue/profitability information is acceptable, the method proceed to block 226, and the general investment criteria is determined to be satisfied. On the other hand, if the revenue/profitability information is determined to be not acceptable, the method proceed to block 227, and the general investment criteria is determined to be not satisfied. At block 228, the method then returns to block 230 of the method illustrated in FIG. 2, and no investment is made.

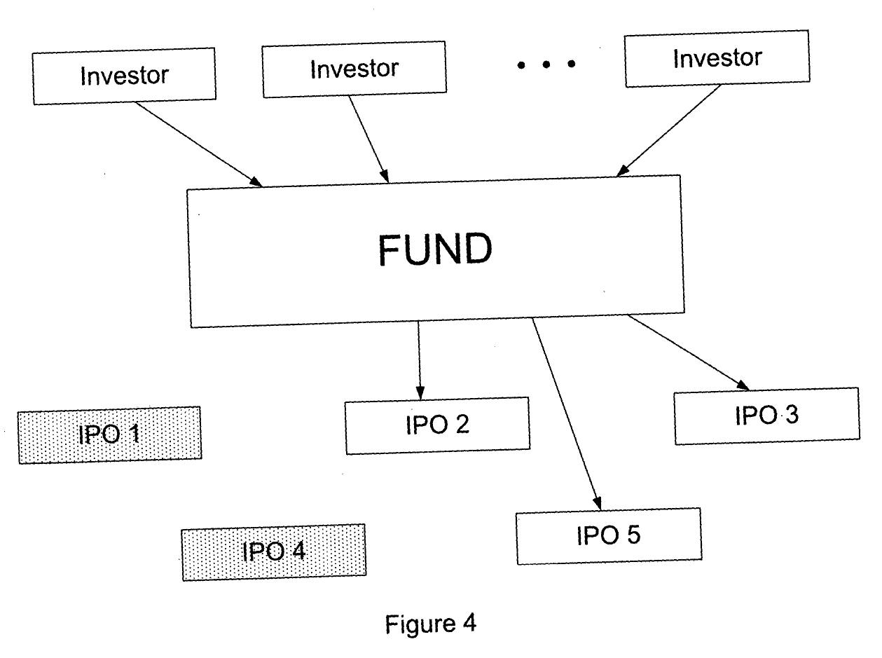

FIG. 4 illustrates the selection of the investment opportunities from those investment opportunities illustrated in FIG. 1 according to an embodiment of the present invention. Funds are provided by investors into the investment vehicle or fund. Application of the general investment criteria, as exemplarily illustrated in FIG. 3, investment opportunities associated with Companies 2, 3 and 5 are selected. Company 1 is eliminated since it includes no pre-IPO private-equity funding. Further, Company 4 is eliminated despite the private-equity funding since the private-equity funding was from a venture fund and Company 4 may not have satisfied the revenue/profitability criteria (block 224 of FIG. 3).

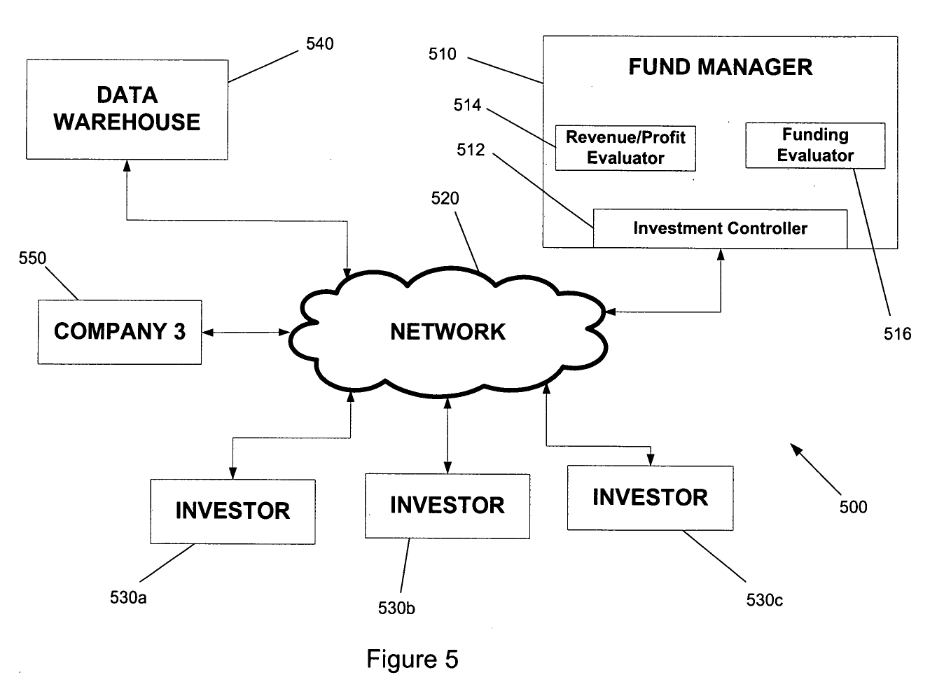

Referring now to FIG. 5, an investment system according to an embodiment of the invention is illustrated. The investment system 500 includes a fund manager, which may be implemented on an investment server 510. The investment server may be a computer that is provided with server software to enable it to engage in a server-client communications with other computers, for example. The investment server 510 may be provided with software modules to perform various functions. For example, a funding evaluator module 516 may be provided to determine the source of the pre-IPO funding of the investment opportunity. Further, a revenue/profit evaluator module 514 may be provided to determine whether the revenue/profit criteria is satisfied by the investment opportunity. An investment controller module 512 may be provided to make a final determination on the investment and to calculate a level of investment, for example.

The investment server 510 may be adapted to communicate with other devices through a network 520. The network 520 may be a private or a public network. In one embodiment, the network 520 is a public network, such as the Internet. In other embodiments, the network 520 may be a communication network, such as a telephone network.

The investment server 510 may be adapted to communicate with one or more investor terminals 530a-c. Each investor terminal may be a desktop, a laptop or a handheld device, for example. Using the investor terminals 530a-c, investors may direct the investment server 510 to consider investing in an investment opportunity, such as Company 3. In this regard, the investment server 510 may communicate directly with a computer 550 at Company 3 through the network 520.

Further, the system 500 may include a data warehouse 540 accessible through the network 520. the data warehouse 540 may be adapted to provide information relating to the investment opportunity, such as information relating to the sources of pre-IPO funding and revenue/profitability information. The data warehouse 540 may include a storage device such as a database containing information for one or more entities. The system 500 illustrated in FIG. 5 may be used to implement the investment methods according to embodiments of the invention. For example, the exemplary methods outlined in FIGS. 2 and 3 may be implemented in the system 500. In such an implementation, an investment opportunity may be received (block 210 of FIG. 2) by the investment server 510 from an investor 530a through the network 520. Information may be received by the investment server 510 relating to pre-IPO funding (block 222 of FIG. 3) and/or revenue/profitability data (block 224 of FIG. 3) from the data warehouse 540 or Company 3 550, for example.

Thus, the embodiments of the invention provide for investing with reduced risk.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

What is claimed is:

1. An investment method, comprising:
selecting a post-IPO investment opportunity for investing only if pre-IPO funding of the post-IPO investment opportunity includes private-equity funding.

2. The method of claim 1, further comprising:
determining, if the private-equity funding includes venture funding, whether the post-IPO investment opportunity satisfies revenue or profitability criteria.

3. The method of claim 2, wherein the revenue or profitability criteria is predetermined.

4. The method of claim 2, wherein the revenue or profitability criteria is based on at least one of the following factors: size of investment, size of an entity affiliated with the investment opportunity and number of employees.

5. The method of claim 2, further comprising:
determining a level of investment in the post-IPO investment opportunity.

6. The method of claim 5, further comprising:
providing funds for investment in the post-IPO investment opportunity corresponding to the level of investment.

7. The method of claim 1, further comprising:
determining a level of investment in the post-IPO investment opportunity.

8. The method of claim 7, further comprising:
providing funds for investment in the post-IPO investment opportunity corresponding to the level of investment.

9. An investment vehicle, comprising:
an investment fund for providing investment capital for a post-IPO investment opportunity, the post-IPO investment opportunity being selected only if pre-IPO funding of the post-IPO investment opportunity includes private-equity funding.

10. The investment vehicle of claim 9, wherein the post-IPO investment opportunity is selected for investment by determining, if the private-equity funding includes venture funding, whether the post-IPO investment opportunity satisfies revenue or profitability criteria.

11. The investment vehicle of claim 10, wherein the revenue or profitability criteria is predetermined.

12. The investment vehicle of claim 10, wherein the revenue or profitability criteria is based on at least one of the following factors: size of investment, size of an entity affiliated with the investment opportunity and number of employees.

13. An investment system, comprising:
means for selecting a post-IPO investment opportunity for investing only if pre-IPO funding of the post-IPO investment opportunity includes private-equity funding.

14. The system of claim 13, further comprising:
means for determining, if the private-equity funding includes venture funding, whether the post-IPO investment opportunity satisfies revenue or profitability criteria.

15. The system of claim 14, further comprising:
means for determining a level of investment in the post-IPO investment opportunity.

16. The system of claim 15, further comprising:
means for providing funds for investment in the post-IPO investment opportunity corresponding to the level of investment.

17. A program product, comprising machine readable program code for causing a machine to perform the following method step:
selecting a post-IPO investment opportunity for investing only if pre-IPO funding of the post-IPO investment opportunity includes private-equity funding.

18. The program product of claim 17, further comprising machine readable program code for causing a machine to perform the following method step:
determining, if the private-equity funding includes venture funding, whether the post-IPO investment opportunity satisfies revenue or profitability criteria.

19. The program product of claim 18, wherein the revenue or profitability criteria is predetermined.

20. The program product of claim 18, wherein the revenue or profitability criteria is based on at least one of the following factors: size of investment, size of an entity affiliated with the investment opportunity and number of employees.

21. The program product of claim 18, further comprising machine readable program code for causing a machine to perform the following method step:
determining a level of investment in the post-IPO investment opportunity.

22. The program product of claim 21, further comprising machine readable program code for causing a machine to perform the following method step:
providing funds for investment in the post-IPO investment opportunity corresponding to the level of investment.

23. The program product of claim 17, further comprising machine readable program code for causing a machine to perform the following method step:
determining a level of investment in the post-IPO investment opportunity.

24. The program product of claim 23, further comprising machine readable program code for causing a machine to perform the following method step:
providing funds for investment in the post-IPO investment opportunity corresponding to the level of investment.

25. An investment system, comprising:
an investment server adapted to select a post-IPO investment opportunity for investing only if pre-IPO funding of the post-IPO investment opportunity includes private-equity funding.

26. The investment system of claim 25, wherein the investment server is adapted to receive data related to the post-IPO investment opportunity from a data warehouse.

27. The investment system of claim 26, wherein the investment server includes a funding evaluator module adapted to determine pre-IPO funding based on data received from the data warehouse.

28. The investment system of claim 25, wherein the investment server includes a revenue/profit evaluator module adapted to determine, if the private-equity funding includes venture funding, whether the post-IPO investment opportunity satisfies revenue or profitability criteria

29. A computer-implemented investment method, comprising:
automatically selecting a post-IPO investment opportunity for investing only if pre-IPO funding of the post-IPO investment opportunity includes private-equity funding.

30. The method of claim 29, further comprising:
determining, if the private-equity funding includes venture funding, whether the post-IPO investment opportunity satisfies revenue or profitability criteria.
